(19) United States
(12) Patent Application Publication
(10) Pub. No.: US 2020/0029209 A1
(43) Pub. Date: Jan. 23, 2020

(54) SYSTEMS AND METHODS FOR MANAGING WIRELESS COMMUNICATIONS BY A VEHICLE

(71) Applicants: Henrik Ferdinand Nölscher, Ulm (DE); Francisco Javier Vazquez Vidal, Ulm (DE)

(72) Inventors: Henrik Ferdinand Nölscher, Ulm (DE); Francisco Javier Vazquez Vidal, Ulm (DE)

(21) Appl. No.: 16/042,832

(22) Filed: Jul. 23, 2018

(51) Int. Cl. H04W 12/02; H04W 4/44; H04W 48/16; H04W 12/04; H04L 9/08; H04L 9/32; H04L 9/30

(52) U.S. Cl. CPC H04W 12/02; H04W 4/44; H04W 48/16; H04W 12/04; H04W 4/46; H04L 9/3268; H04L 9/085; H04L 9/30; H04L 9/3242; H04L 9/0819

(57) ABSTRACT

Disclosed is a method and apparatus for a vehicle forming a local communications connection with a network node. The method may include discovering, by the vehicle, the network node for establishment of a wireless network connection between the vehicle and the network node. The method may also include exchanging one or more wireless communications with the network node to negotiate one or more parameters of the wireless network connection to be established, wherein the one or more wireless communications are encrypted using a shared network encryption key, and wherein the one or more parameters comprise at least one session key associated with the wireless network connection. Furthermore, the method may include establishing the wireless network connection with the network node, and exchanging wireless communications with the network node via the established wireless network connection.

### FIELD

The disclosed embodiments relate generally to vehicle systems and in particular, but not exclusively, to enabling wireless communications between a vehicle and a communications node.

### BACKGROUND

Vehicles, such as cars, trucks, trains, etc., are becoming more connected. That is, a vehicle may include network communication capabilities enabling the vehicle to communicate via a network, such as a wide area network (e.g., cellular communications network), local communication network (e.g., a residential network), a personal area network (e.g., a network established between two devices), as well as other wireless communication networks. The vehicle may use one or more of the different types of network to establish a connection with, and exchange messages, between other device(s) via the network connections. For example, the vehicle may provide diagnostics information, receive software and firmware updates, etc. via a network connection to a remote maintenance management server. Driving conditions, such as within a city scape, in remote regions, and in other areas of low service availability, may prevent the vehicle's access to the communications network. Thus, the vehicle may be unable to exchange data with remote servers during these periods of no network connectivity.

As another example of a type of network connection established by the vehicle, the vehicle may directly communicate with other vehicles. Such a local connection and/or direct communications connection enables the vehicle to establish position, exchange driving strategies, transmit warnings, etc. However, the establishment of a connection, or local network, with another vehicle, another network device, etc., does not necessarily establish a trusted relationship with the other vehicle and/or device, or trust in the information exchanged with the other vehicle and/or device.

When two or more systems, such as a combination of vehicles and network nodes, directly connect with one another, a peer-to-peer network may be established that connects directly and/or indirectly each peer in the network with the other peers in the network. That is, each system in the peer-to-peer network may share resources with one another without having to go through a server computer system. Furthermore, a direct connection may not be needed to share information indirectly between peers, such as by using an intermediary peer. While peer-to-peer networking helps to expand the reach of computer networks and distribute networking loads and tasks, there are drawbacks when applied to vehicles. As discussed in Peer-to-Peer Networking: A coming of Age (Judy Hartley, Mar. 7, 2012), data exchanged within the peer-to-peer network is not necessarily encrypted, and therefore may be readable by any party. For vehicles that travel between in public spaces, the vulnerabilities associated with data security and privacy are exposed to both benign and nefarious parties. Furthermore, authentication of a party that a peer is directly and/or indirectly connected to may be weak. In other words, a system may not be able to establish trust and/or an identity of a party they are directly connected to, leading to low levels of trust in all of the peers in a network. Then, if data is being distributed in such a network with low levels of trust and authentication, the connections and the data being distributed between those peers inherits the low levels of trust.

### BRIEF DESCRIPTION OF THE DRAWINGS

FIG. 1 is a block diagram of an exemplary system architecture for establishing a local network connection between a vehicle and one or more nodes of a communications network;

FIG. 2 is block diagram of one embodiment of a system including a vehicle and another system in communication with one another;

FIG. 3A is a flow diagram of one embodiment of a method for a vehicle establishing a local network connection for communicating with a node;

FIG. 3B illustrates one embodiment of a generated broadcast message and the resulting encrypted broadcast message;

FIG. 4A is a flow diagram of another embodiment of a method for a vehicle establishing a local network connection for communicating with a node;

FIG. 4B illustrates one embodiment of a generated parameter proposal message;

FIG. 5 is a flow diagram of one embodiment of a method for a vehicle negotiating local network connection parameters for the exchange of subsequent wireless communications using the local network connection; and

FIG. 6 is a block diagram of an exemplary system for wireless communications exchanged between a vehicle, other nodes, and a remote server using a peer-to-peer network.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

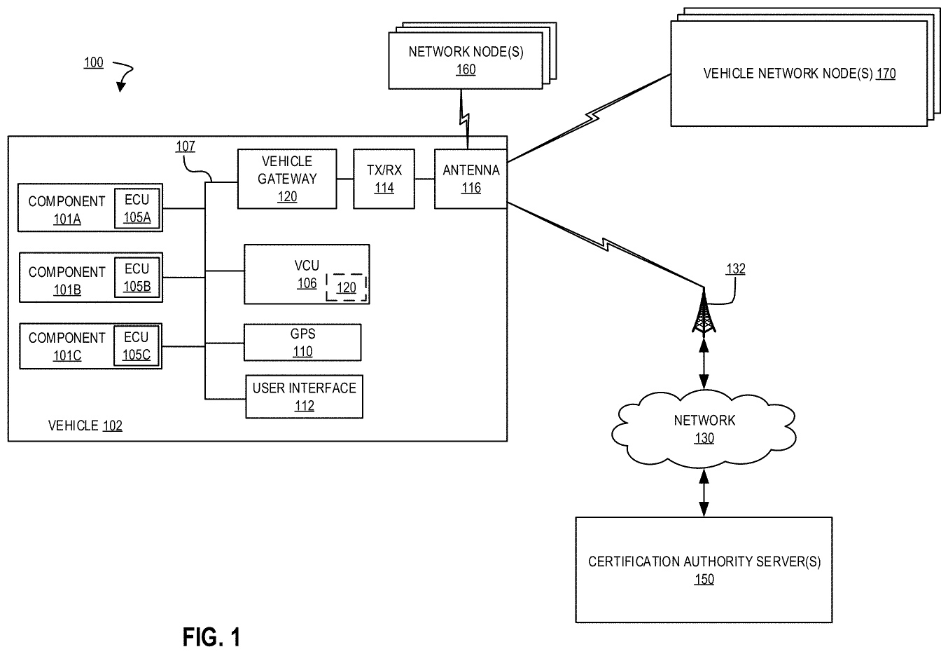

FIG. 1 is a block diagram of an exemplary system architecture for establishing a local network connection between a vehicle 102 and one or more nodes of a communications network. In the embodiments discussed herein, system 100 enables vehicle 102 to establish trusted and reliable channels of authenticated wireless communication between vehicle 102 and other vehicles and network equipment (e.g., one or more of network node(s) 160 and/or one or more of vehicle network node(s) 170). Furthermore, the established channels of wireless communication further address and safeguard the privacy of an operator of the vehicle.

In embodiments, vehicle 102 may be a fully electric vehicle, partially electric (i.e., hybrid) vehicles, non-electric vehicles (i.e., vehicle with a traditional internal combustion engine). Furthermore, although described mostly in the context of automobiles, the illustrated systems and methods can also be used in other wheeled vehicles such as trucks, motorcycles, electronic bicycles, buses, trains, etc. It can also be used in non-wheeled vehicles such as ships, airplanes (powered or gliders), drones, and rockets. In fact, the illustrated embodiments can be used in any situation in which it is useful to establish local and/or temporary wireless network connections with other nodes in a communications network.

In embodiments, vehicle network node(s) 170 may also be a combination of fully electric vehicles, partially electric (i.e., hybrid) vehicles, non-electric vehicles, trucks, motorcycles, buses, trains, etc. capable of performing the wireless communication and authentication techniques discussed herein. Furthermore, the network node(s) 160 may be stationary and/or mobile devices, such as traffic lights, access points, etc. that are also capable of performing the wireless communication and authentication techniques discussed herein. As discussed in greater detail herein, vehicle 102, network node(s) 160, and vehicle network node(s) 170 are each nodes in a network formed by a plurality of local area network connections between nodes.

In embodiments, certification authority server(s) 150 are remote servers that provide certification authority services, such as issuing identifiers to network nodes, generating and distributing public/private encryption keys, issuing certificates to network nodes, signing certificates, revoking certificates, verifying data within certificates, etc. Certification authority server(s) 150 may perform any of the services typically associated with certification authority systems. Certification authority server(s) 150 may be a single server computer system, or may be comprised of two or more server computer systems distributed over a network 130 (e.g., the Internet, a private network, or other network).

System 100 includes vehicle 102 communicatively coupled to any combination of network node(s) 160, vehicle network node(s) 170, and certification authority server(s) 150. In the context of this application, “communicatively coupled” means coupled in such a way that data can be exchanged, in one or both directions, between two entities or components (e.g., between the vehicle 102 and any of network node(s) 160, vehicle network node(s) 170, and certification authority server(s) 150).

In embodiments, each of vehicle 102, network node(s) 160, vehicle network node(s) 170, and certification authority server(s) 150 are associated with a manufacturer, such as a manufacturer of vehicles. For example, vehicle 102 and vehicle network node(s) 170 may be vehicles built by the manufacturer, network node(s) 160 may be devices (e.g., smart traffic lights, smart street signs, access points, etc.) placed by the manufacturer, and certification authority server(s) 150 may be run by, or their operation under the control of, the manufacturer. Thus, a network, similar to an internet or intranet, may be formed between the vehicles, network nodes, and remote servers, as discussed herein. In embodiments, one or more elements of authentication data (e.g., encryption key(s)) is shared and/or known by each of the systems of the manufacturer. However, in some embodiments, the network need not be restricted by a common manufacturer, and may instead be any collection of vehicles, network nodes, and/or remote servers that share authentication data and perform the techniques discussed in greater detail herein.

In one embodiment, vehicle 102 includes one or more systems, such as components 101, each having an electronic control unit (ECU) 105, and each ECU 105 is communicatively coupled via a communications network 107 to a vehicle control unit (VCU) 106. The communications network 107 may be a controller area network (CAN), an Ethernet network, a wireless communications network, another type of communications network, or a combination of different communication networks. VCU 106 is also communicatively coupled to a GPS unit 110, a user interface 112, and a transceiver 114. Transceiver 114, is a vehicle to anything (V2X), wireless fidelity, wide area network, or a combination of transceivers, that is communicatively coupled to an antenna 116, through which vehicle 102 can wirelessly transmit data to, and receive data from, any of certification authority server(s) 150, network node(s) 160, and vehicle network node(s) 170 using protocols for the exchange of information. In the illustrated embodiment, vehicle 102 communicates wirelessly via antenna 116 with a tower 132, which can then communicate via network 130 (e.g., a cellular communication network, a local area network, a wide area network, etc.) with certification authority server(s) 150. In embodiments, the vehicle 102 communicates with certification authority server(s) 150 and/or other remote server(s) when a wireless connection with tower 132 is available.

Components 101 are generally components of the systems of the vehicle 102. For example, components 101 can include adjustable seat actuators, power inverters, window controls, electronic braking systems, etc. Vehicle control unit (VCU) 106 is a controller including a microprocessor, memory, storage, and a communication interface with which it can communicate with components 101, global positioning system (GPS) 110, user interface 112, and transceiver 114 via network 107. In one embodiment VCU 106 is the vehicle's main computer, but in other embodiments it can be a component separate from the vehicle's main or primary computer.

In one embodiment, vehicle 107 includes vehicle gateway 120. Vehicle gateway 120 is a networking appliance that resides on vehicles communications network 107. Vehicle gateway 120 may include a network interface, processor, memory, and one or more processing modules. In one embodiment, vehicle gateway 120 may reside in VCU 106, as well as in other components with sufficient access to network 107, processing power, and memory resources to perform the operations described in greater detail herein.

In embodiments, vehicle gateway 120 may be a hardware security module that provides a secure computing and storage environment, which is isolated from other processing and memory of vehicle 102. For example, vehicle gateway 120 may perform processes such as broadcasting for new network connections, establishing secure network connections with nodes (e.g., one or more of nodes 160 and 170), performing encryption of network communications, exchanging information with certification authority server(s) 150, negotiating wireless connection parameters and/or session keys for a new network connection, etc., as will be discussed in greater detail herein.

In embodiments, as noted above, the vehicle gateway 120 may be a hardware security module that performs node authentication and/or secure communication processes. Furthermore, as a hardware security module, vehicle gateway 120 may provide a secure storage for sensitive information, such as signed certificates of the vehicle, encryption keys, session encryption keys, vehicle identifiers, etc. In the event the vehicle 102, security gateway 120, or other sensitive component of the vehicle 102 becomes compromised, the secure storage of vehicle gateway 120 may be erased to maintain the security of the keys, certificates, and other data (e.g., user information) that may be maintained in the vehicle gateway 120. To this end, vehicle gateway 120 implements one or more physical and logical barriers for accessing the vehicle gateway 120. Vehicle gateway 120 may include pressure switches, electrical connectors, etc. that detects physical access to the internal components of the vehicle gateway 120, such as attempts to open a container housing the vehicle gateway 120. Vehicle gateway 120 may also include one or more software components that detect disallowed logical accesses to the internal components of the vehicle gateway 120, such as attempts to access secure storage, reprogram, or otherwise tamper with the operation of vehicle gateway 120, as well as detection of disallowed accesses or actions with respect to any of the systems of vehicle 102. As a hardened appliance, in response to detecting a non-allowed physical or logical access, vehicle gateway 120 responds by taking one or more actions (e.g., shutting down, entering a safe mode, wiping storage and loading a clean configuration, etc.).

Vehicle gateway 120 performs one or more security functions for communications sent/received from vehicle. In embodiments, small and/or local network connections are continually established between vehicle 102 and any combination of node(s) (e.g., network node(s) 160 and/or vehicle network node(s) 170). For example, a local network connection may have a range of 10 meters, 100 meters, 1 kilometer, etc., and as vehicle 102 moves during operation, vehicle 102 is continuously coming within, or leaving, communication range with other network nodes capable of performing the processes discussed herein. Therefore, to ensure privacy and security in the established connections, and the data exchanged subsequent to establishing connections, for each new network connection that is to be established between vehicle 102 and another network node (160 or 170), vehicle gateway performs an initial discovery and handshaking process. In embodiments, as discussed in greater detail below, the discovery and handshaking process are used by each node (e.g., vehicle 102 and the other network nodes, such as 160 or 170) to broadcast messages for discovering other nodes of the network, verify each other's identity, establish that each has access to certain shared information (e.g., a network encryption key), and establish session encryption keys or other connection parameters (e.g., wireless communication channel parameters) for all communications exchanged between the vehicle 102 and the network node (160 or 170) after the handshaking process is performed. Such communications can include, for example, data shared between nodes (e.g., transmission of files, software updates, firmware updates, etc.), short message (e.g., traffic warnings, diagnostic events, etc.), relaying connections between nodes and/or a connection to network 130, as well as communication of other data.

In one embodiment, the system 100 may be used to establish a peer-to-peer network, in which vehicle 102 is a node within the peer-to-peer. For example, FIG. 6 is a block diagram of an exemplary system for wireless communications exchanged between the vehicle 102, other nodes (e.g., nodes 660-1, 660-2, through 660-N), and a remote server 662 using a peer-to-peer network 600. In embodiments, the peer-to-peer network 600 relies on the broadcast message exchange, handshaking process (e.g., identify and authority verification, parameter proposal exchange, and session key establishment) to secure the channels of communication between peers in the network 600. For example, vehicle 102 performs the handshaking process with each of the nodes (e.g., nodes 660-1 and 660-2), to which vehicle is directly connected, to establish trust and a secure communications channel with each node. Furthermore, each of the nodes also performs the handshaking process with the nodes to which they are directly connected. Because each node performs the processes, as discussed in greater detail below, vehicle 102 is able to trust the chain of peers in the established peer-to-peer network 600. Any number of additional nodes and/or topographies of the peer-to-peer network may be established using the techniques discussed herein to secure the channels of communication between each node. Furthermore, any of a range of peer-to-peer networking and/or peer-to-peer file transmission protocols can be used in conjunction with the secure communication techniques, discussed in greater detail below.

In embodiments, nodes, such as node 660-N, which are not in range of a local connection (e.g., >1 km) with vehicle 102 can be connected via one or more intermediate peers (e.g., node 660-2). Thus, vehicle 102 can receive data from and transmit data to remote server 662 via peer nodes 660-N through 660-2 using peer-to-peer file sharing techniques, even when vehicle 102 lacks a connection to wide area network to which remote server 662 is connected. Furthermore, even if a connection to a wide area network is available, vehicle 102 may receive data (e.g., software updates, entertainment data, etc.) via the peer-to-peer network 600 in order to conserve bandwidth and the usage of individual connections to remote server 662. The exchange of messages in the peer-to-peer network 600 may be exchanged using the secure communications established herein.

Furthermore, the communications reach of vehicle 102 is therefore extended geographically (e.g., vehicle 102 being connected via intermediate nodes to node 660-N which is out of direct communication range), and logically (e.g., remote server 662 being accessible by node 660-N via a cellular or hard-wired network connection, where vehicle 102 can access node 660-N via the peer-to-peer network). This enables peer-to-peer data distribution in network 600 including, for example, short message alerts such as those generated by a node/vehicle in response to a monitored road or traffic condition that vehicle 102 has not yet encountered but which is on vehicle's 102 route of travel, data exchanges including those generated by a remote manufacturer or service server (e.g., server 662) that are to be distributed to all manufacturers' nodes (e.g., security updates, firmware updates, new network keys, software system updates, etc.), partial or incremental data transfers using peer-to-peer data sharing protocols (e.g., a node may receive/request a portion of data (e.g., a portion of firmware update) that it may already have a portion of (e.g., started to receive update when it had wide area network access to remote server 662, then lost access, and using data sharing over the network 600 to obtain the remainder of the firmware update), determining an approximate location of vehicle 102 using the peer-to-peer network 600 (e.g. using location data of peers and/or the network to relay the location to remove server 662 when vehicle 102 does not GPS reception and/or the ability to communicate their location to remote server 662), as well as other exchanges of data using the peer-to-peer network 600 and the connection of at least one peer to remote server 662.

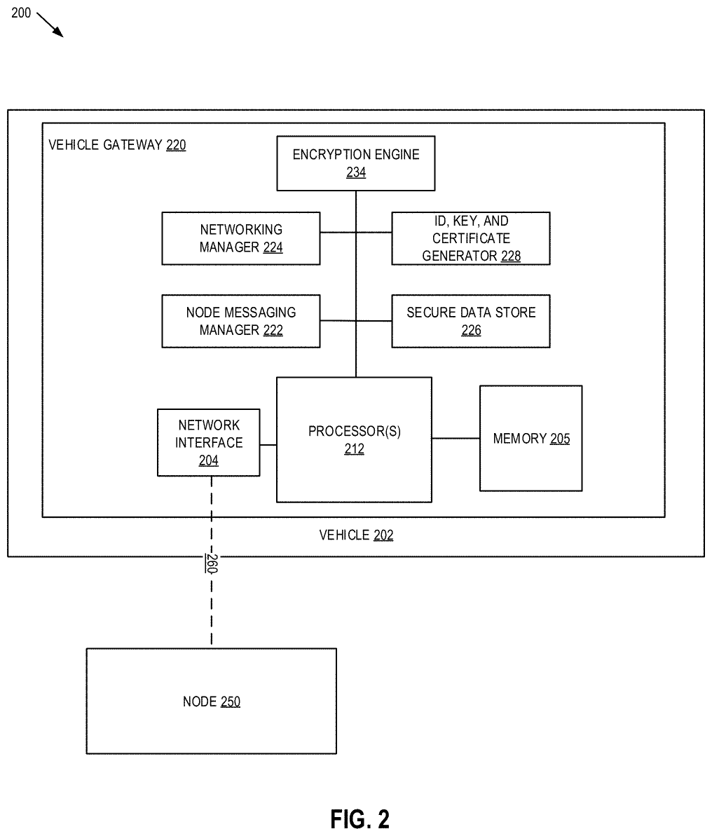

FIG. 2 is block diagram of one embodiment of a system 200 including a vehicle 202 and node 250. Vehicle 202 provides additional details for vehicle 102 discussed above in FIG. 1.

In the embodiment illustrated in FIG. 2, although vehicle 202 is shown communicatively coupled via a wireless link 260 to node 250, vehicle may be communicatively coupled with any number of additional nodes (not shown), node 250 may be coupled with any number of additional nodes (not shown), and any of the nodes may be communicatively coupled with one or more remote server(s) (e.g., a certification authority server, a manufacturer server, etc.). As discussed herein, the wireless communication links (e.g., link 260) establish direct and indirect connections between nodes and remote servers, thereby forming a peer-to-peer communications network including vehicle 202.

In one embodiment, vehicle 202 is a system, which may include one or more processor(s) 212, a memory 205, and a network interface 204. It should be appreciated that vehicle 202 may also include, although not illustrated, a user and/or hardware interface, vehicle controls, one or more power device(s) (e.g., vehicle battery), drive control system, one or more vehicle systems (e.g., VCUs, components, positioning systems, etc.), a propulsion system (e.g. an electric, gasoline, natural gas, hybrid, etc. powered motor), a steering system, a braking system, as well as other components typically associated with vehicles. Although only a single network interface 204 is illustrated, it is understood that network interface 204 may be capable of communicatively coupling vehicle 202 to any number of nodes using one or more wireless subsystems (e.g., Bluetooth, WiFi, Cellular, or other networks) to transmit and receive data streams through one or more communication links (e.g., link 260).

In one embodiment, node 250 is also a system, which may include one or more processor(s), a memory, and communications subsystem. It should be appreciated that node 250 may also include, although not illustrated, a user interface (e.g., keyboard, touch-screen, or similar devices), a power device (e.g., a battery), a display screen (e.g., an LCD display), as well as other components typically associated with computer processing systems. Furthermore, node 250 may be any of the nodes illustrated in FIG. 1, such as a network node (e.g., smart traffic light, smart roadway sign, network access point, etc.) or a vehicle network node (e.g., another vehicle similar to vehicle 102), so long as the node has the processing and functional capabilities to perform the discovery, verification, parameter negation, and encryption processes discussed herein.

In embodiments, memory 205 of vehicle 202 may be coupled to processor(s) to store instructions for execution by one or more processors, such as processor(s) 212. In some embodiments, the memory is non-transitory, and may store one or more processing modules. In one embodiment, memory 205 of vehicle 202 may store one or more processing modules of a vehicle gateway 220, such as an encryption engine 234, a networking manager 224, a node messaging manager 222, an ID, key, and certificate generator 228, and a secure data store 226 to implement embodiments described herein.

It should be appreciated that the embodiments as described herein may be implemented through the execution of instructions, for example as stored in memory or other element, by processor(s) 212 and/or other circuitry of vehicle 202. Particularly, circuitry of vehicle 202, including but not limited to processor(s) 212, may operate under the control of a program, routine, or the execution of instructions to execute methods or processes in accordance with the aspects and features described herein. For example, such a program may be implemented in firmware or software (e.g. stored in memory 205) and may be implemented by processor(s) 212, and/or other circuitry. Further, it should be appreciated that the terms processor, microprocessor, circuitry, controller, engine, manager, generator, etc., may refer to any type of logic or circuitry capable of executing logic, commands, instructions, software, firmware, functionality and the like.

Further, it should be appreciated that some or all of the functions, engines, or modules described herein may be performed by vehicle 202 itself and/or some or all of the functions, engines or modules described herein may be performed by another system connected through network interface 204 to vehicle 202. Thus, some and/or all of the functions may be performed by another system, and the results or intermediate calculations may be transferred back to vehicle 202. In some embodiments, such other system may comprise a server (not shown).

In one embodiment, vehicle 202 includes vehicle gateway 220. Vehicle gateway 220 may be a hardened network appliance, such as a hardware security module. The vehicle gateway 220 may therefore be physically and/or logically isolated from other processing and/or storage resources of the vehicle 202. For example, vehicle gateway 220 implemented in a hardware security module ensures that the processes performed by the vehicle gateway are free from attacks, that sensitive information (e.g., encryption keys, identifiers, certificates, session logs, etc.) is maintained in a secure location within vehicle 202, and that the processes using the sensitive information are performed within the logical and/or physical isolation of the hardware security module. Furthermore, as discussed above, the vehicle gateway 220 may be executed by a hardware security module that resides in the main processing unit of vehicle 202 (e.g., the VCU 106, as well as other processing unit of vehicle 202 capable of providing secure processing and memory resources).

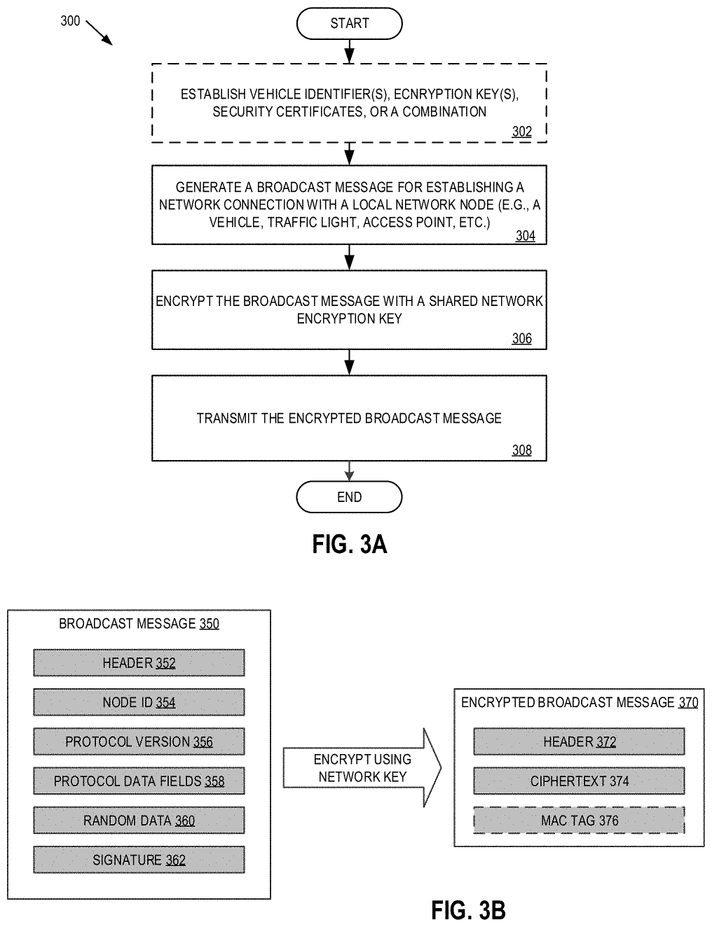

In one embodiment, networking manager 224 is responsible for establishing the wireless communications link with node 250. To this end, in embodiments, networking manager 224 generates and causes the transmission of broadcast discovery messages as discussed below in FIG. 3 (e.g., discovery messages sent to node 250), as well as processes received broadcast discovery messages (e.g., discovery messages received from node 250). In one embodiment, networking manager 224 utilizes encryption capabilities of encryption engine to encrypt broadcast discovery messages prior to transmission, and decrypt received broadcast discovery messages. In one embodiment, encryption engine 234 may perform symmetric encryption techniques (e.g., CCM or GCM mode of Advance Encryption Service (AES) encryption), asymmetric encryption techniques (e.g., Rivest-Shamir-Adleman (RSA) encryption), message authentication code (MAC) tag generation and verification, Diffie-Hellman (DH) exchanges, nonce data insertion in exchanged messages (e.g., arbitrary random numbers prepended to an encrypted message payload and used only once during cryptographic message exchange to ensure message freshness, to prevent replay attacks, and to serve as an initialization vector or nonce for the encryption process itself), as well as other encryption techniques. In one embodiment, networking manager 224 utilizes encryption engine 234 to encrypt or decrypt the discovery messages using a shared network key that is maintained in secure data storage 226. In embodiments, the shared network key is a key that is generated by a trusted entity, such as the vehicle's manufacturer, a security service, a certificate authority system, or any other trusted third party, and securely distributed to each device associated with a manufacturer. Since each device should know and have access to the shared key, encryption engine 234 is able to using a symmetric encryption method, for example AES-CCM, AES-GCM, etc., for encrypting/decrypting the broadcast message and also verifying that the node 250 is part of the manufacturer's network of vehicles.

In one embodiment, when networking manager 224 of vehicle 202 receives and is able to successfully decrypt a broadcast discovery message of node, the encryption engine 234 performs one or more additional encryption processes, such as MAC tag verification in the received message, node ID authentication (using a signature and identifier using certificate authority services), generating a twice encrypted response (e.g., encrypted using a public key of node 250 and the network key) including one or more communication parameter proposal(s), and then transmitting a parameter proposal message to node 250.

However, when networking manager 224 of vehicle 202 receives a parameter proposal message from node 250 (e.g., in response to vehicles broadcast discovery message), networking manager 224 uses encryption engine 234 to perform complimentary operation to those discussed above. In embodiments, the operations can include MAC tag verification in the received message, decryption using a shared network key stored in secure data storage 226, decryption using the private key of the vehicle stored in secure data storage 226, validation of the sending node's signature (e.g., using a certificate authority and signatures/IDs in the decrypted message), generating a twice encrypted response (e.g., encrypted using a public key of node 250 and the network key) including one or more communication parameter proposal responses, and then transmitting a parameter proposal response message to node 250.

In embodiments, the network broadcast message generation and transmission, as well as receipt, can continue as communication parameters are negotiated and/or generated. In embodiments, the parameter generation can include the establishment and sharing of asymmetric session encryption keys (e.g., sharing of public keys with private keys secured by vehicle 202 and node 250). In other embodiments, the parameter generation and negotiation can include the exchange of a series of messages (e.g., a DH exchange) for the establishment and sharing of a symmetric session encryption key. In either embodiment, subsequent communications and data exchanged between vehicle 202 and node 250 may be secured using the negotiated session parameters (e.g., encryption key(s)). In embodiments, node messaging manager 222 uses the established session encryption key(s) with encryption engine 234 to encrypt/decrypt communications with node 250.

As a result, a secure communications channel is created between vehicle 202 and node 250. As discussed herein, vehicle 202 or node 250 may be peers in a peer-to-peer network linking vehicles, network nodes, and remote servers. Furthermore, each communications link is secured and identities of peers verified prior to communication exchange. Therefore, trust is established not only between the two entities in direct wireless communication (e.g. vehicle 202 and node 250), but between each peer including direct and indirect peers. Thus, when data is exchanged, distributed, requested, etc. in the peer-to-peer network, the data and sources inherit the established trust. As such a secure and trusted network of vehicles and network nodes is established using the techniques discussed herein.

In embodiments, further security may be established by ID, key, and certificate generator 228. In embodiments, each time vehicle 202 is turned or powered on for operation, one or more pieces of data used for establishing wireless communication connection is generated. In embodiments, ID, key, and certificate generator 228 may generate one or more of a new vehicle identifier, encryption keys, or certificates tied to the new identifier and/or encryption keys. For example, ID, key, and certificate generator 228 may include a certificate authority service that generates a new certificate tied to a chain of certificates back to a root certificate authority associated with a manufacturer of the vehicle. As another example, a new vehicle identifier is generated each time the vehicle is turned on, but a new certificate is generated less periodically (e.g., each day, once a week, once a month, etc.). By changing this data, additional security is added to anonymize each vehicle. In embodiments, ID, key, and certificate generator 228 stores the new IDs, key, and/or certificates in secure data storage 226 for later use consistent with the discussion herein.

In one embodiment, further security may be established by networking manager 224 logging the establishment of a communications sessions, such as the one established with node 250. For example, the node identifier of node 250 exchanged for the communications session may be stored to a session log maintained within secure data store 226 or elsewhere within memory 205. Furthermore, the log may include data, such as the duration of the connection maintained between vehicle 202 and node 250. The history of established connections, which may be limited to a certain number of entries, a freshness of entries, etc., and their associated durations, may be used by a security monitoring system of vehicle (not shown), a third party server (e.g., a manufacturer's security server), another security service, etc. to perform security monitoring for vehicle 202. In embodiments, the session log stores the node identifiers exchanged for each session and connection duration, which enables further security improvements for vehicle (e.g., being able to audit or analyze various connections), as well as anonymity of vehicles that are logged, using the techniques discussed herein.

FIG. 3A is a flow diagram of one embodiment of a method 300 for a vehicle establishing a local network connection for communicating with a node. The method 300 is performed by processing logic that may comprise hardware (circuitry, dedicated logic, etc.), software (such as is run on a general purpose computer system or a dedicated machine), firmware, or a combination. In one embodiment, the method 300 is performed by a vehicle gateway of a vehicle (e.g., vehicle gateway 120 or 220 of vehicle 102 or 202).

Referring to FIG. 3A, processing logic begins by establishing vehicle identifier(s), encryption key(s), security certificate(s) or a combination thereof (processing block 302). In one embodiment, identifier(s), encryption key(s), security certificate(s) are used for establishing a wireless communication connection and securing subsequent communications with a node (e.g., another vehicle or a network node) in a peer-to-peer network. In embodiments, processing block 302 is performed periodically (e.g., each time vehicle is turned on, at a present time interval, etc.). Furthermore, each of the identifier(s), encryption key(s), security certificate(s) may be generated at different intervals. For example, vehicle identifiers for wireless communication sessions may be established every hour regardless of whether the vehicle is turned on/off, while a security certificate is generated by processing logic each time the vehicle is started on a new day, after 24 hours if the vehicle is not turned off before that time passes, or in another periodic interval that may be different from that in which the vehicle identifiers are established. In one embodiment, when a new vehicle security certificate is generated, processing logic can chain the new certificate to a central certificate authority (e.g., a certification authority of the vehicle's manufacturer or a trusted third party certification authority).

Processing logic then generates a broadcast message for establishing a network connection with a local network node (processing block 304). As discussed herein, the node may be any of a vehicle, network device (e.g. traffic light, access point, etc.), as well as other devices capable of performing the operations discussed herein. In one embodiment, processing logic of the vehicle maintains an ID for the vehicle, which is tied to a public and private key, and verifiable via a security certificate, as discussed herein. Processing logic utilizes this data to generate a broadcast message that can be encrypted, decrypted by other nodes, and an identity of the vehicle authenticated from the broadcast message contents. FIG. 3B illustrates one embodiment of a generated broadcast message and the resulting encrypted broadcast message. In one embodiment, the broadcast message 350 can include a plurality of fields, including a message header 352, a node ID 354, a protocol version 356 (e.g., indicating message protocol, networking protocol, encryption protocol, etc.), protocol data fields 358 (e.g., describing the protocols and/or setting protocol options), random data 360 (e.g., a timestamp, data generated with a random number generator, a dynamically generated hash value, or other constantly changing data), and a signature 362 (e.g. a signature from a security certificate of the vehicle). In one embodiment, the node ID 354 is a combination of a random node ID (e.g., periodically generated by processing logic) and the vehicle's public key (e.g., which may also be periodically generated and associated with a security certificate).

In embodiments, processing logic further maintains and has access to a shared network encryption key. In embodiments, as discussed herein, the shared network encryption key is a network-wide key that is securely distributed to vehicles and network nodes by a manufacturer of the vehicle, a party that established the peer-to-peer network, or some other trusted party. New shared network encryption keys may be periodically distributed to vehicles and network nodes. Therefore, processing logic encrypts the broadcast message with the shared network security key (processing block 306). In one embodiment, processing logic utilizes AES-CCM mode encryption, which is a symmetric encryption technique capable of utilizing the shared network security key (e.g., can only be decrypted by other nodes/vehicles that have the shared network security key). In FIG. 3B the encrypted broadcast message 370, which is generated by encrypting the contents of the broadcast message using the shared network encryption key, may include additional data fields, such as a message header 372 and a MAC tag 376 generated using the shared network encryption key (e.g. a short piece of data that is used to authenticate the contents of the broadcast message), which are added along with the ciphertext 374 containing the encrypted version of the broadcast message.

It is noted that the broadcast message includes the random data (e.g., a timestamp, hash value, random number, etc.) inserted into the message contents prior to encryption so that no two broadcast messages that are generated and encrypted by the vehicle are the same, even when new IDs, certificates, etc. have been generated. The difference in broadcast message content ensures that the vehicle cannot be tracked via the broadcast message transmission (e.g., by network devices, cell towers, access points, etc.). Furthermore, in embodiments, additional data, such as nonce or other freshness day may also be added to encrypted broadcast message 370 to further enhance message security.

Processing logic then transmits the encrypted broadcast message (processing block 308). In embodiments, the vehicle utilizes a transmitter configured for establishing local network connections with one or more proximately located network nodes. For example, the transmitter may be able to transmit broadcast discovery messages reliably for a maximum range (e.g., 1 kilometer), so that local networks between the vehicle and a network node can be continuously established as the vehicle travels, encounters new nodes, leaves range of node to which vehicle is currently connected, etc.

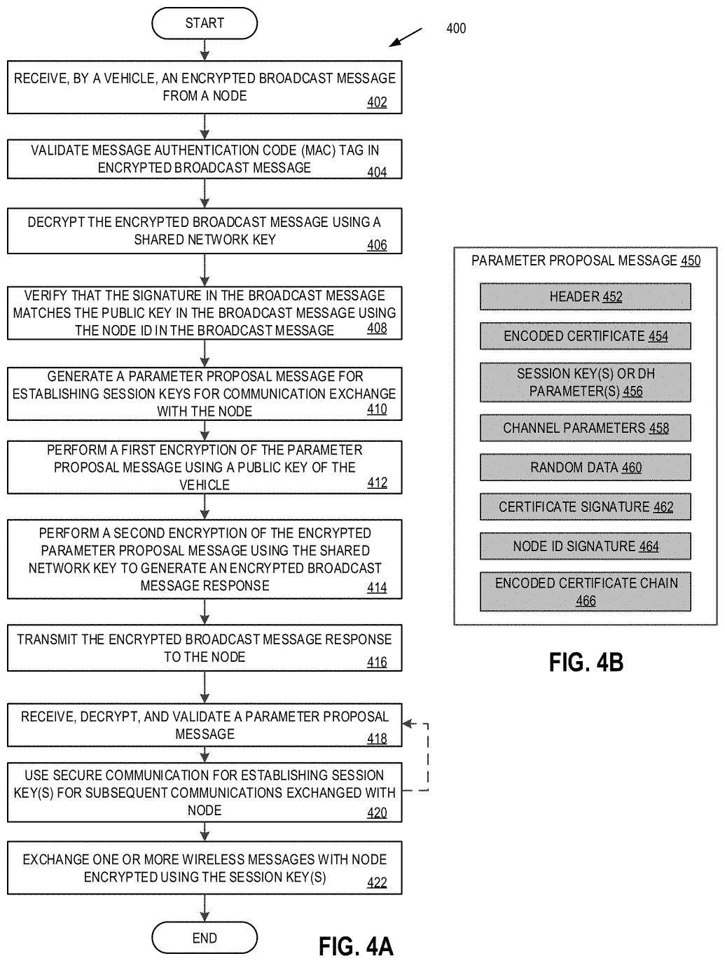

FIG. 4A is a flow diagram of another embodiment of a method 400 for a vehicle establishing a local network connection for communicating with a node. The method 400 is performed by processing logic that may comprise hardware (circuitry, dedicated logic, etc.), software (such as is run on a general purpose computer system or a dedicated machine), firmware, or a combination. In one embodiment, the method 400 is performed by a vehicle gateway of a vehicle (e.g., vehicle gateway 120 or 220 of vehicle 102 or 202).

Referring to FIG. 4A, processing logic begins by receiving, by a vehicle, an encrypted broadcast discovery message from a node (processing block 402). In one embodiment, the broadcast discovery message is generated and encrypted by the node as discussed above in FIGS. 3A and 3B. Furthermore, although FIG. 4A discusses processing logic executed by a vehicle, any of the nodes (e.g. vehicle, smart traffic light, access point, etc.) discussed herein may be used to implement the process of FIG. 3A to transmit the broadcast message and establish a local network communications connection with the node using the process of FIG. 4A.

Processing logic validates the MAC tag in the encrypted broadcast message (processing block 404). In one embodiment, the MAC tag may be decrypted and/or analyzed using the shared network encryption key to validate the received message before decrypting the message's ciphertext, which also verifies that the transmitting node is using the shared network encryption key. In embodiments, use of a MAC tag in messaging exchanged between local network nodes is optional. However, once the MAC tag is validated, processing logic may then decrypt the encrypted broadcast message (e.g., the ciphertext) using the shared network encryption key (processing block 406). As discussed herein, processing logic may use a symmetric encryption technique, such as AES-CCM, AES-GCM, etc., to decrypt the encrypted broadcast message

Once successfully decrypted, processing logic verifies that the signature in the broadcast message matches the public key (e.g., in the Node ID data field) in the broadcast message using the node ID (e.g., extracted from the Node ID data field 354) (processing block 408). In one embodiment, the signature and public key can be verified using a certificate authority system verification technique (e.g., using a chain of certs stored by processing logic, accessing a remote certificate authority, etc.).

Processing logic then generates a parameter proposal message for establishing session keys for communication exchange with the node (processing block 410). FIG. 4B illustrates one embodiment of a generated parameter proposal message 450. The parameter proposal message can include various data fields, such as a header 452 (e.g., indicating the type of message and other elements related to the message), an encoded certificate 454 (e.g., associated with the vehicle/node generating the message), proposed session key or Diffie-Hellman (DH) exchange parameters 456, channel parameters 458 (e.g., specifying various communication channel settings and options), random data 460, a certificate signature 462 (e.g., associated with encoded certificate 454), a nodeID signature 464, and an encoded certificate chain 466 (e.g., a security certificate chain from the node/vehicle to vehicle manufacture's root certificate server, to enable verification of the vehicle belonging to the fleet of vehicles and other nodes of the manufacturer).

In embodiments, data field 456 may be either proposed session keys or a Diffie-Hellman (DH) exchange generated key. A DH exchange key is a symmetric encryption key that is cooperatively generated by processing logic of the vehicle and the node, in one embodiment. The DH exchange can be statically defined, but it can also depend on the contents of the messages exchanged between the vehicle and the node (e.g. at processing blocks 418-420). The DH exchange can lead to a more secure key and/or encryption for subsequent message exchange, and in embodiments, may be exchanged before exchanging and validating certificates. In another embodiment, proposed session keys are asymmetric keys generated by each party (e.g. the vehicle and the node). That is, vehicle can encrypt subsequent communications using the node's proposed key, and vice versa.

In embodiments, as discussed herein, the encoded certificate may be a static certificate, which is issued once per vehicle and signed by a certificate authority operated by the manufacturer (or a third party trusted by, or under the direction of, the manufacturer). A certificate chain may then be stored on each car in the secure data store 226, so that vehicle can verify the certificates of other nodes. In another embodiment, the vehicle can have its own certificate authority that issues temporary certificates. This may be beneficial in the event that the network encryption key is ever compromised. The temporary certificates would again be part of the certificate chain to a root certificate of the manufacturer. Thus, the manufacturer could revoke certificates periodically, in response to user requests, in response to certain events (e.g., detected data and/or security breaches, detected malicious activity, etc.), etc.

Processing logic of FIG. 4A then performs a first encryption of the parameter proposal message using a public key of the vehicle (processing block 412), and performs a second encryption of the encrypted parameter proposal message using the shared network encryption key to generate an encrypted broadcast message response (processing block 414). In one embodiment, the encrypted broadcast message response may have the same format as the encrypted broadcast message 370 in FIG. 3B. Furthermore, a MAC tag, a header, and additional data (e.g., nonce or other freshness data) may be added by processing logic to the encrypted broadcast message response.

Processing logic then transmits the encrypted broadcast message response to the node (processing block 416). Processing logic may then receive, decrypt, and validate a parameter proposal message from the node (processing block 418) and use secure communications for establishing session key(s) for subsequent communications exchanged with the node (processing block 420). As indicated by the dashed arrow, several messages may be exchanged between processing logic of the vehicle and the node, for example during the generation and suggesting of asymmetric encryption keys, or during a DH exchange.

Once the session key(s) are established, processing logic exchanges one or more wireless messages with the node using the session key(s) (processing block 422). Now that the vehicle and the node have validated one another and established session key(s), they may securely communicate with one another as long as the session key(s) remain valid. The exchanged messages can include peer-to-peer network messages for data distribution, generation and or receipt of alerts, updates (e.g., software, system, firmware, etc.) distributed via a peer-to-peer network, traffic notifications, etc.

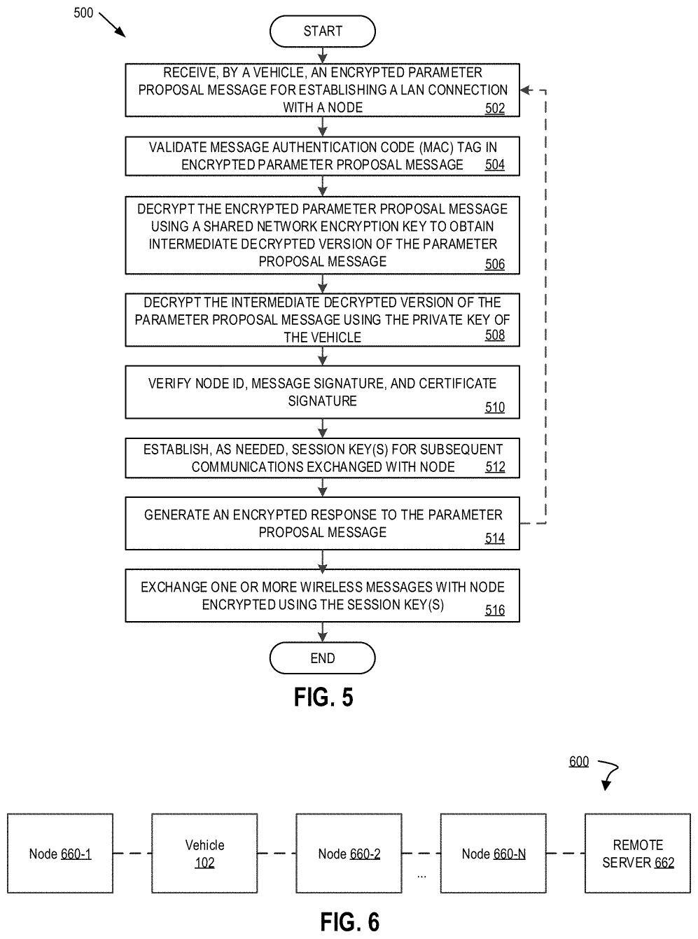

FIG. 5 is a flow diagram of one embodiment of a method 500 for a vehicle negotiating local network connection parameters for the exchange of subsequent wireless communications using the local network connection. The method 500 is performed by processing logic that may comprise hardware (circuitry, dedicated logic, etc.), software (such as is run on a general purpose computer system or a dedicated machine), firmware, or a combination. In one embodiment, the method 500 is performed by a vehicle gateway of a vehicle (e.g., vehicle gateway 120 or 220 of vehicle 102 or 202).

Referring to FIG. 5, processing logic begins by receiving, by a vehicle, an encrypted parameter proposal message for establishing a local area network connection with a node (processing block 502). In on embodiment, the encrypted parameter proposal message is the same type and format of message generated at processing block 416 of FIG. 4A, discussed above.

When the encrypted parameter proposal message includes a MAC tag, processing logic validates the MAC tag in the encrypted parameter proposal message (processing block 504). In one embodiment, the verification includes using the shared network encryption key to decrypt the MAC tag and perform a MAC verification process to authenticate that the message's contents have not been altered, and the correct shared network encryption key is being used. Processing logic then decrypts the encrypted parameter proposal message using the shared network encryption key to obtain an intermedia decrypted version of the parameter proposal message (processing block 506), and decrypts the intermedia decrypted version of the parameter proposal message using the private key of the vehicle (processing block 508).

Once decryption is complete, the node ID, certificate signature, certificate, and certificate chain in the fully decrypted version of the parameter proposal message can be verified (processing block 510), as discussed herein. Processing logic may then establish session key(s) for subsequent communications exchanged with the node (processing block 512). For example, one or more messages may participate in an DH exchange process in which symmetric keys are generated cooperatively over one or more exchanged messages. As another example, an asymmetric public key private key pair for ruse with RSA, or similar, encryption is generated by processing logic. An encrypted response to the parameter proposal message is generated (processing block 514). For example, processing logic may return to processing block 502 to receive a response (e.g., to a series of DH exchange messages).

However, once the session keys are established, processing logic exchanges one or more wireless messages with the node encrypted using the session key(s) (processing block 516). As discussed above, the messages are encrypted using the negotiated encryption keys so that subsequently exchanged communications between the vehicle and the node are secured from unwanted disclosure. Furthermore, the established trust during the handshaking and parameter exchange are used as trust that can be inherited in other communication in a peer-to-peer network for data sharing and distribution.

Therefore, in view of the discussion set forth herein, the problems associated with trust, authentication, and data security in direct network connections are solved by the techniques, processes, and systems discussed herein. That is, the handshaking process authenticates the parties to one another, as well as well as established a party's proper role within a vehicle manufacturer's network. Furthermore, encryption keys and other data are exchanged and/or established using the techniques discussed herein to protect the data exchanged in the established connections. Additionally, using the techniques and data exchanged in each message, unwanted tracking is prevented thereby increasing privacy for the parties implementing the technique discussed herein.

Those of skill would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the methods, systems, and apparatus of the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for a vehicle forming a local communications connection with a network node, the method comprising:
discovering, by the vehicle, the network node for establishment of a wireless network connection between the vehicle and the network node;
exchanging one or more wireless communications with the network node to negotiate one or more parameters of the wireless network connection to be established, wherein the one or more wireless communications are encrypted using a shared network encryption key, and wherein the one or more parameters comprise at least one session key associated with the wireless network connection;
establishing the wireless network connection with the network node; and
exchanging wireless communications with the network node via the established wireless network connection, wherein at least a portion of contents of each wireless communication is encrypted using the at least one session key.

2. The method of claim 1, wherein the discovering further comprises:
generating a broadcast message for establishing the wireless network connection with the network node, wherein the broadcast message comprises a node identifier of the vehicle, a random data, and a signature associated with a security certificate of the vehicle;
encrypting the broadcast message using the shared network security key; and
wirelessly transmitting the encrypted broadcast message for receipt by one or more network nodes.

3. The method of claim 2, further comprising:
receiving an encrypted version of a parameter proposal message from the network node, wherein the network node received the encrypted broadcast message;
decrypting the encrypted version of a parameter proposal message using the shared network encryption key to generate an intermediate decrypted version of the parameter proposal message;
decrypting the intermediate decrypted version of the parameter proposal message using a private encryption key of the vehicle to extract a node identifier, security certificate, and certificate signature of the network node;
verifying the extracted node identifier and certificate signature of the network node match the security certificate of the network node using a certificate authority; and
generating a parameter proposal response message comprising one or more session keys generated in whole or in part by the vehicle that are to be used in the established wireless network connection.

4. The method of claim 1, wherein the discovering and the exchanging of one or more wireless communications with the network node to negotiate one or more parameters of the wireless network connection to be established, further comprises:
receiving an encrypted broadcast message from the network node;
decrypting ciphertext in the encrypted broadcast message using the shared network encryption key to extract node identification data and a signature from a security certificate of the network node;
extracting a public encryption key associated with the node and an identifier of the network node form the node identification data;
verifying that the public key matches the security certificate associated with the signature based on the identifier of the network node.

5. The method of claim 4, wherein in response to the verifying the public key matches the security certificate, the method further comprises:
generating a parameter proposal message comprising one or more session keys generated in whole or in part by the vehicle that are to be used in the established wireless network connection;
encrypting the parameter proposal message with the public encryption key of the network node to generate a first encrypted version of the parameter proposal message;
encrypting the first encrypted version of the parameter proposal message with the shared network encryption key to generate a second encrypted version of the parameter proposal message; and
transmitting the second encrypted version of the parameter proposal message to the network node.

6. The method of claim 4, wherein the encrypted broadcast message from the network node comprises a message authentication code (MAC) tag added by the network node to the encrypted broadcast message, further comprising:
verifying, prior to decrypting the ciphertext, the MAC tag using the shared network encryption key; and
in response to verification of the MAC tag, performing the decryption of the ciphertext.

7. The method of claim 1, wherein the shared network encryption key and the at least one session key are stored in a hardware security module of the vehicle.

8. The method of claim 1, wherein the at least one session key associated with the wireless network connection comprises a symmetric session encryption key cooperatively generated by the vehicle and the network node.

9. The method of claim 1, wherein the at least one session key associated with the wireless network connection comprises an exchange of a first session public encryption key associated with the vehicle and a second session public encryption key associated with the network node.

10. The method of claim 1, further comprising:
forming a second wireless network connection between the vehicle and a second network node, wherein the second wireless network connection utilizes different parameters and a different at least one session key.

11. The method of claim 10, wherein the wireless network connection between the vehicle and the network node, and the second wireless network connection formed between the vehicle and the second network node, are wireless network connections formed in a peer-to-peer network that comprises at least the vehicle, the network node, and the second network node.

12. The method of claim 11, wherein a traffic warning is distributed to the vehicle via the peer-to-peer network, wherein the traffic warning is generated by a third network node in the peer-to-peer network based on a traffic condition encountered by the third network node, wherein the third network node is wirelessly connected to the peer-to-peer network, and wherein the vehicle does not have an established direct wireless communications with the third network node.

13. The method of claim 1, wherein the network node maintains a connection to a remote server via a wide area network connection, and wherein the vehicle is unable to obtain a wide area network connection to the remote server, the method further comprising:
receiving data, using the established local communication connection, from the network node, the data generated by the remote server.

14. The method of claim 1, wherein the network node is a second vehicle.

15. The method of claim 1, wherein the network node is a device comprising one of a smart traffic light, a smart roadway sign, or a network access point.

16. The method of claim 1, wherein the shared network encryption key is a key that is periodically generated by a trusted entity and securely distributed to the vehicle and the network node, and wherein each of the one or more wireless communications exchanged with the network node to negotiate the one or more parameters of the wireless network connection to be established utilizes symmetric encryption using the shared network encryption key to encrypt at least a portion of the contents of the one or more wireless communications.

17. The method of claim 1, wherein prior to the discovering, the method further comprises:
generating one or more of a new vehicle identifier, a new vehicle encryption keys, and a new vehicle security certificate based on the new vehicle identifier and the new vehicle encryption keys to be used by the vehicle when establishing wireless network connections with one or more network nodes.

18. The method of claim 17, wherein the generating is performed in response to the vehicle being turned on.

19. The method of claim 18, wherein the generating is performed periodically.

20. The method of claim 1, further comprising:
generating an entry in a session log for each wireless network connection established by the vehicle, wherein each entry in the session log comprises a node identifier of a network node with which a wireless connection has been established and a duration of the wireless connection that has been logged.

21. The method of claim 20, wherein the session log is maintained in a memory of a hardware security module of the vehicle, and wherein the entry is generated in the session log by a processor of the hardware security module.

22. A non-transitory machine readable storage medium having instructions stored thereon, which when executed by a processing system of a vehicle, causes the processing system to perform one or more operations for a vehicle forming a local communications connection with a network node, the one or more operations comprising discovering, by the vehicle, the network node for establishment of a wireless network connection between the vehicle and the network node;
exchanging one or more wireless communications with the network node to negotiate one or more parameters of the wireless network connection to be established, wherein the one or more wireless communications are encrypted using a shared network encryption key, and wherein the one or more parameters comprise at least one session key associated with the wireless network connection;
establishing the wireless network connection with the network node; and
exchanging wireless communications with the network node via the established wireless network connection, wherein at least a portion of contents of each wireless communication is encrypted using the at least one session key.

23. The non-transitory machine readable storage medium of claim 22, wherein the discovering further comprises:
generating a broadcast message for establishing the wireless network connection with the network node, wherein the broadcast message comprises a node identifier of the vehicle, a random data, and a signature associated with a security certificate of the vehicle;
encrypting the broadcast message using the shared network security key; and
wirelessly transmitting the encrypted broadcast message for receipt by one or more network nodes.

24. The non-transitory machine readable storage medium of claim 22, further comprising:
forming a second wireless network connection between the vehicle and a second network node, wherein the second wireless network connection utilizes different parameters and a different at least one session key, and
wherein the wireless network connection between the vehicle and the network node, and the second wireless network connection formed between the vehicle and the second network node, are wireless network connections formed in a peer-to-peer network that comprises at least the vehicle, the network node, and the second network node.

25. The non-transitory machine readable storage medium of claim 22, wherein the network node maintains a connection to a remote server via a wide area network connection, and wherein the vehicle is unable to obtain a wide area network connection to the remote server, the one or more operations further comprising:
receiving data, using the established local communication connection, from the network node, the data generated by the remote server.

26. The non-transitory machine readable storage medium of claim 22, wherein prior to the discovering, the one or more operations further comprising:
generating one or more of a new vehicle identifier, a new vehicle encryption keys, and a new vehicle security certificate based on the new vehicle identifier and the new vehicle encryption keys to be used by the vehicle when establishing wireless network connections with one or more network nodes.

27. A vehicle, comprising:
a transceiver for transmitting and receiving wireless message; and
a processor communicably coupled with the transceiver, wherein the processor is configured to:
discover a network node for establishment of a wireless network connection between the vehicle and the network node,
exchange, using the transceiver, one or more wireless communications with the network node to negotiate one or more parameters of the wireless network connection to be established, wherein the one or more wireless communications are encrypted using a shared network encryption key, and wherein the one or more parameters comprise at least one session key associated with the wireless network connection,
establish the wireless network connection with the network node, and
exchange, using the transceiver, wireless communications with the network node via the established wireless network connection, wherein at least a portion of contents of each wireless communication is encrypted using the at least one session key.

28. The vehicle of claim 27, wherein the processor configured to discover further comprises the processor configured to:
generate a broadcast message for establishing the wireless network connection with the network node, wherein the broadcast message comprises a node identifier of the vehicle, a random data, and a signature associated with a security certificate of the vehicle,
encrypt the broadcast message using the shared network security key, and
wirelessly transmit, using the transceiver, the encrypted broadcast message for receipt by one or more network nodes.

29. The vehicle of claim 27, further comprising the processor configured to:
form a second wireless network connection between the vehicle and a second network node, wherein the second wireless network connection utilizes different parameters and a different at least one session key, and
wherein the wireless network connection between the vehicle and the network node, and the second wireless network connection formed between the vehicle and the second network node, are wireless network connections formed in a peer-to-peer network that comprises at least the vehicle, the network node, and the second network node.

30. The vehicle of claim 27, wherein the network node maintains a connection to a remote server via a wide area network connection, and wherein the vehicle is unable to obtain a wide area network connection to the remote server, the processor further configured to:
receive data, using the transceiver and the established local communication connection, from the network node, the data generated by the remote server.

31. The vehicle of claim 27, wherein prior to the discovering, the processor is further configured to:
generate one or more of a new vehicle identifier, a new vehicle encryption keys, and a new vehicle security certificate based on the new vehicle identifier and the new vehicle encryption keys to be used by the vehicle when establishing wireless network connections with one or more network nodes.
